(19) United States
(12) Patent Application Publication
(10) Pub. No.: US 2007/0119488 A1
(43) Pub. Date: May 31, 2007

(54) Dish washer with disc type passage control valve

(76) Inventor: Soon Yong Kwon, Busan (KR)

Correspondence Address: KED & ASSOCIATES, LLP, P.O. Box 221200, Chantilly, VA, 20153-1200, US

(21) Appl. No.: 11/546,563

(22) Filed: Oct. 12, 2006

(30) Foreign Application Priority Data
Oct. 13, 2005 (KR) 10-2005-0096390

(51) Int. Cl. B08B 3/00; B08B 3/12

(52) U.S. Cl. 134/198; 134/103.1; 134/56 D; 134/184

(57) ABSTRACT

A dish washer is disclosed which includes a disc type passage control valve formed to have a simple disc structure, thereby being capable of smoothly supplying wash water to a washing arm. The dish washer includes an upper washing arm, a lower washing arm, a sump for receiving wash water, a washing pump for pumping the wash water, and a passage control valve including a passage opening/closing plate having a plate or disc shape and functioning to open/close a passage guiding the wash water to the upper washing arm or to the lower washing arm.

This application claims the benefit of Korean Patent Application No. 10-2005-0096390 filed on Oct. 13, 2005, which is hereby incorporated by reference as if fully set forth herein.

### BACKGROUND OF THE INVENTION

1. Field of the Invention

The present invention relates to a dish washer for washing dishes, and more particularly, to a dish washer which includes a disc type passage control valve formed to have a simple disc structure, thereby being capable of smoothly supplying wash water to a washing arm.

2. Discussion of the Related Art

Generally, dish washers are adapted to wash dishes by injecting wash water onto the dishes, and to dry and/or sterilize the washed dishes.

Hereinafter, a conventional dish washer will be described with reference to the annexed drawings.

FIG. 1 is a schematic view illustrating a configuration of a conventional dish washer. FIG. 2 is an exploded perspective view illustrating a driver of the dish washer shown in FIG. 1. FIG. 3 is a plan view illustrating a passage structure of a filter housing shown in FIG. 2. FIG. 4 is a sectional view illustrating a flow of wash water during a washing operation of the driver shown in FIG. 2. FIG. 5 is a plan view illustrating a flow of wash water in the filter housing OF FIG. 2 during the washing operation. FIG. 6 is a plan view illustrating a flow of wash water in the filter housing of FIG. 2 during a draining operation.

The configuration of the conventional dish washer will be described in outline with reference to FIG. 1. The dish washer includes a tub 1. Installed in the tub 1 are upper and lower washing arms 4 and 5, upper and lower racks 6 and 7, and a driver 10.

Upper and lower connecting tubes 2 and 3 are connected to the driver 10, in order to pump wash water. A draining hose 9 is also connected to the driver 10, in order to drain wash water. The upper and lower washing arms 4 and 5 are connected to the upper and lower connecting tubes 2 and 3, respectively. The upper rack 6 is arranged over the upper washing arm 4, whereas the lower rack 7 is arranged over the lower washing arm 5.

The upper and lower washing arms 4 and 5 are rotatably mounted above the driver 10. Each of the upper and lower washing arms 4 and 5 are provided with injection holes for injecting wash water. Additional injection holes are also provided at the lower washing arm 5, in order to remove garbage from a filter of the driver 10, and thus, to prevent the filter from being closed by the garbage.

Hereinafter, the driver will be described in detail with reference to FIG. 2. The driver 10 includes a sump 20 for receiving wash water, a heater 30 mounted in the sump 20, to heat the wash water, a washing pump (including elements 41 and 42) mounted to the sump 20, to pump the wash water, a draining pump (including elements 51 and 52) mounted to the sump 20, to drain the wash water, and filtering means for guiding a part of the pumped wash water to the washing arms 4 and 5, and filtering the remaining wash water.

A space for receiving wash water, namely, a wash water receiver 21, is defined in the sump 20. A draining chamber 22 is also defined in the sump 20. The draining chamber 22 is partitioned from the wash water receiver 21. A passage control device 25 is disposed outside the wash water receiver 21. A passage control valve 26 is axially coupled to the passage control device 25.

The washing pump includes a washing motor 41 mounted to the bottom of the sump 20, and adapted to generate a drive force, and an impeller 42 mounted to the filtering means, and adapted to pump wash water, using the drive force of the washing motor 41. A disposer 45 is axially coupled to a shaft of the washing pump. The disposer 45 functions to finely chop garbage as it rotates. A screen 46 having a certain mesh size is arranged over the disposer 45, in order to separate garbage having a large grain size.

The draining pump is mounted to the draining chamber 22 of the sump 20. The draining pump includes a draining motor 51 and an impeller 52.

The filtering means includes a pump housing 60 formed with a space for receiving the impeller 42 therein, a filter housing 70 arranged to cover the top of the pump housing 60, and a cover 80 arranged to cover the top of the filter housing 70 and the top of the sump 20. The pump housing 60 is mounted to the bottom of the filter housing 70. The cover 80 is mounted to the top of the filter housing 70.

A garbage chamber 75 is defined in the filter housing 70. The garbage chamber 75 is provided with a draining member 75a communicating with the draining chamber 22. The draining member 75a is downwardly protruded from the garbage chamber 75 by a certain length such that the draining member 75a is inserted into the draining chamber 22. Details of the filter housing 70 will be described later.

A filter 81 is mounted in the cover 80 such that the filter 81 faces the garbage chamber 75. A plurality of recovering holes 82 are formed at the cover 80 outside the filter 81. The recovering holes 82 communicate with the sump 20.

The filter housing 70 will now be described with reference to FIG. 3.

The filter housing 70 includes a wash water inlet 72 for receiving wash water pumped by the impeller 42, main passages 73a and 73b connected to the wash water inlet 72, a sampling passage 74 connected to the wash water inlet 72, and a garbage chamber 75 connected to the sampling passage 74. An opening/closing valve is arranged in the draining member 75a of the garbage chamber 75, in order to discharge wash water and garbage from the garbage chamber 75 to the draining chamber 22 (FIG. 2) during a draining operation.

The passage control valve 26 is rotatably seated in the wash water inlet 72 of the filter housing 70, to selectively open and close the main passages 73a and 73b. The passage control valve 26 is axially coupled to the passage control device 25 (FIG. 2) installed in the sump 20. An opening/closing lip 26a is formed at the periphery of the passage control valve 26, to selectively open and close the main passages 73a and 73b.

Hereinafter, operation of the dish washer having the above-mentioned configuration will be described.

The dish washer washes dishes while sequentially or selectively performing pre-washing, main washing, rinsing, hot rinsing, and drying operations. A draining operation is carried out between adjacent ones of the above-mentioned operations. The main washing operation and draining operation will be described hereinafter.

When the main washing operation is begun, the washing motor 41 rotates, thereby causing the impeller 42 to rotate. As a result, the impeller 42 pumps wash water (containing a detergent) from the sump 20 to the wash water inlet 72 (FIG. 3) of the pump housing 60.

In this case, in accordance with rotation of the passage control device 25, the passage control valve 26 can simultaneously open the two main passages 73a and 73b, as shown in FIG. 3, or can selectively open one of the main passages 73a and 73b, as shown in FIGS. 5 or 6. Accordingly, a part of the wash water received in the wash water inlet 72 is introduced into the upper washing arm 4 and/or the lower washing arm 5 via the main passage 73a and/or main passage 73b. The remaining wash water is introduced into the garbage chamber 75 via the sampling passage 74.

In this case, the passage control valve 26 simultaneously or alternately opens the main passages 73a and 73b, to supply wash water to both the upper and lower washing arms 4 and 5. At the same time, a part of the wash water is always introduced into the sampling passage 74, irrespective of which main passage is opened by the passage control valve 26.

The wash water introduced in the sampling passage 74 is directly introduced into the garbage chamber 75. This wash water then overflows the filter 81 (FIG. 2) arranged over the garbage chamber 75. At this time, the filter 81 filters the wash water to remove foreign matter from the wash water. The filter wash water is returned to the sump 20 via the recovering holes 82 of the cover 80, together with wash water discharged from the upper and lower washing arms 4 and 5.

Although the wash water seems to be partially filtered in the above procedure carried out for a short period of time, most wash water is, in practical, filtered during the main washing operation. After completion of the washing operation, the draining operation is begun.

When the draining operation is begun, the draining pump operates. At this time, the wash water and garbage in the sump 20 are introduced into the draining pump by virtue of a suction force generated by the draining pump. At the same time, the wash water and garbage in the garbage chamber 75 are also introduced into the draining pump via the draining member 75a, as shown in FIG. 6. The wash water and garbage introduced in the draining pump are then outwardly discharged through the draining hose 9 (FIG. 1).

In the above-mentioned conventional dish washer, however, it is impossible to smoothly supply wash water to the washing arms because the passage control valve has a complex structure. In order to eliminate this problem, it is necessary to increase the capacity of the washing pump.

Furthermore, although the passage control valve is rotated using a motor, to perform a passage control operation, this operation is carried out in a state in which wash water is filled in the passage control valve. As a result, a large load is applied to the motor. For this reason, the motor must have an increased capacity, in order to smoothly rotate the passage control valve.

In addition, the conventional passage control valve is expensive because its structure is complex. As a result, the manufacturing costs of the dish washer are increased.

### SUMMARY OF THE INVENTION

Accordingly, the present invention is directed to a dish washer with a disc type passage control valve that substantially obviates one or more problems due to limitations and disadvantages of the related art.

An object of the present invention is to provide a disc type passage control valve capable of smoothly supplying wash water to a washing arm, and a dish washer provided with the disc type passage control valve.

Another object of the present invention is to provide a disc type passage control valve which is efficiently rotatable, using a motor having a small capacity, and a dish washer provided with the disc type passage control valve.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dish washer comprises: an upper washing arm; a lower washing arm; a sump for receiving wash water; a washing pump for pumping the wash water; and a passage control valve including a passage opening/closing plate having a plate shape and functioning to open/close a passage guiding the wash water to the upper washing arm or to the lower washing arm.

Preferably, the passage opening/closing plate has a disc shape.

Preferably, the passage control valve has a rotating shaft. The rotating shaft connects the passage opening/closing plate to a motor. When the motor rotates, the passage opening/closing plate is rotated, thereby opening or closing the passage.

The passage opening/closing plate may comprise an upper washing arm opening portion for opening a passage communicating with the upper washing arm, a lower washing arm opening portion for opening a passage communicating with the lower washing arm, and a passage closing portion for selectively closing the passage communicating with the upper washing arm or the passage communicating with the lower washing arm.

The dish washer may further comprise a pumping chamber where an impeller of the washing pump is arranged, and a housing assembly having a passage control chamber communicating with the upper washing arm and the lower washing arm.

Preferably, the passage opening/closing plate is arranged in a passage defined in the passage control chamber to communicate with the upper washing arm and the lower washing arm.

In accordance with the present invention, when wash water is guided to the washing arms, the flow of the wash water can be smoothly carried out. Accordingly, the supply of the wash water can be smoothly achieved. As a result, it is possible not only to achieve an enhancement in washing performance, but also to relatively reduce the capacity of the washing pump. Also, there is no problem associated with the supply of wash water to the washing arms, even when the washing pump exhibits a degraded performance after being used for a prolonged period of time.

Since no load caused by wash water is applied to the passage control valve when passage control is carried out by rotating the passage control valve using a control motor, in accordance with the present invention, differently from the conventional case, it is possible to extend the life span of the motor, and thus, to more efficiently use the motor.

The passage control valve of the present invention is simple, and thus, inexpensive, as compared to the conventional passage control valve. Accordingly, it is possible to reduce the manufacturing costs of the dish washer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating a configuration of a conventional dish washer;

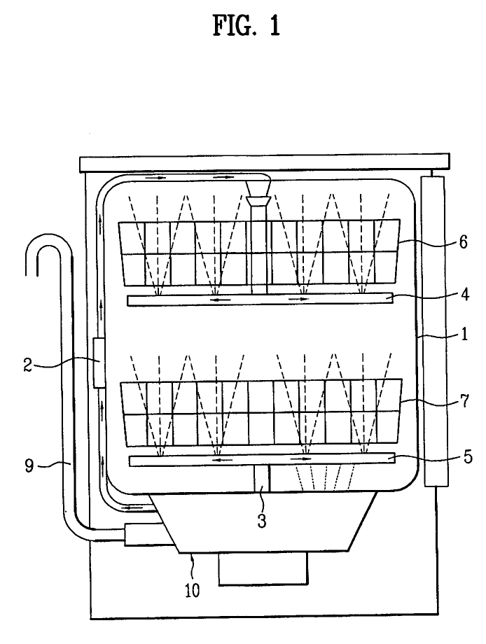

FIG. 2 is an exploded perspective view illustrating a driver of the dish washer shown in FIG. 1;

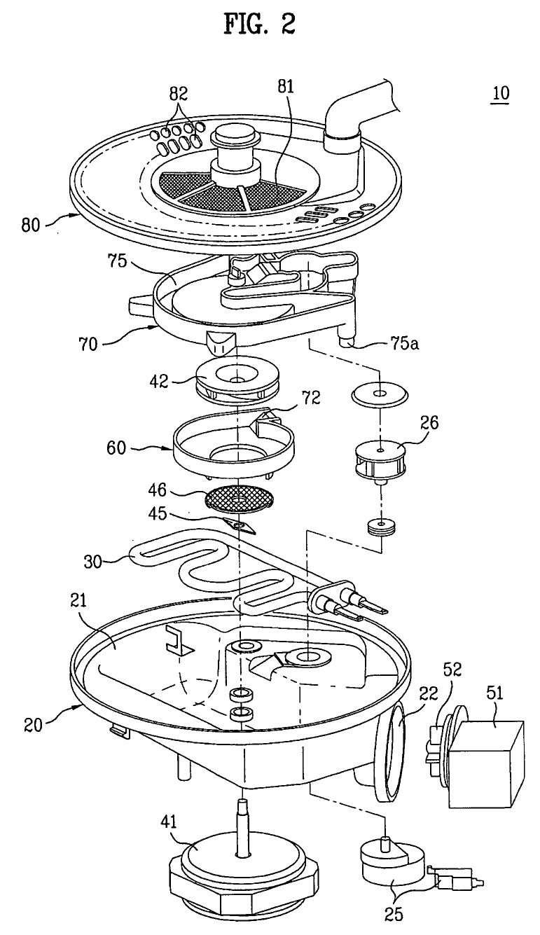

FIG. 3 is a plan view illustrating a passage structure of a filter housing shown in FIG. 2;

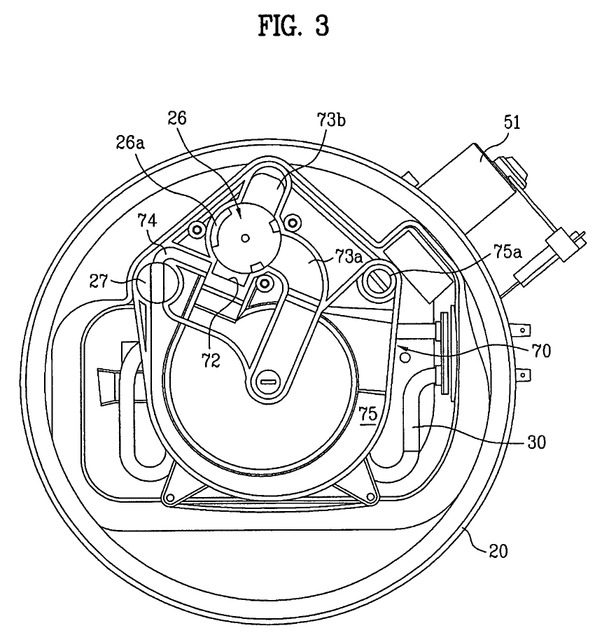

FIG. 4 is a sectional view illustrating a flow of wash water during a washing operation of the driver shown in FIG. 2;

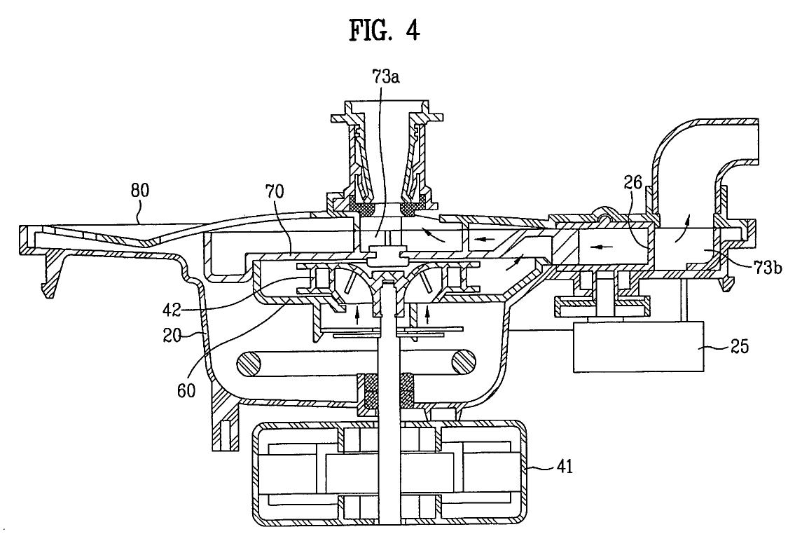

FIG. 5 is a plan view illustrating a flow of wash water in the filter housing of FIG. 2 during the washing operation;

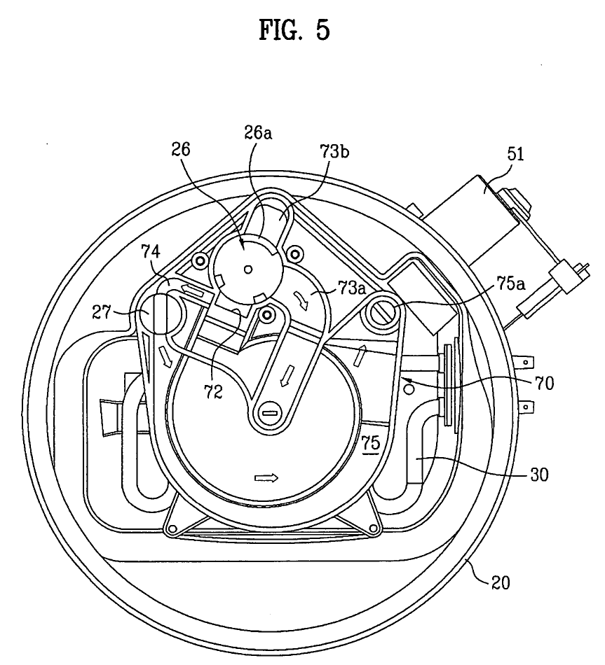

FIG. 6 is a plan view illustrating a flow of wash water in the filter housing of FIG. 2 during a draining operation;

FIG. 7 is a schematic view illustrating a disc type passage control valve for a dish washer according to a preferred embodiment of the present invention;

FIG. 8 is an exploded perspective view illustrating a configuration of a dish washer according to the present invention;

FIG. 9 is a sectional view illustrating a flow of wash water during a washing operation of the dish washer of FIG. 8; and

FIG. 10 is a sectional view illustrating a flow of wash water during a draining operation of the dish washer of FIG. 8.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

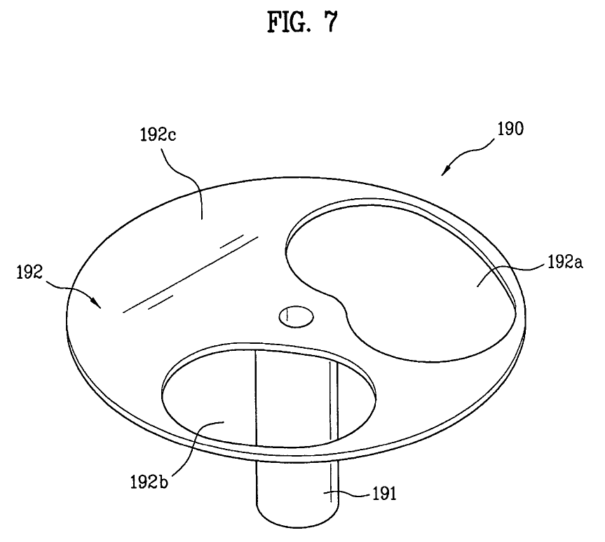

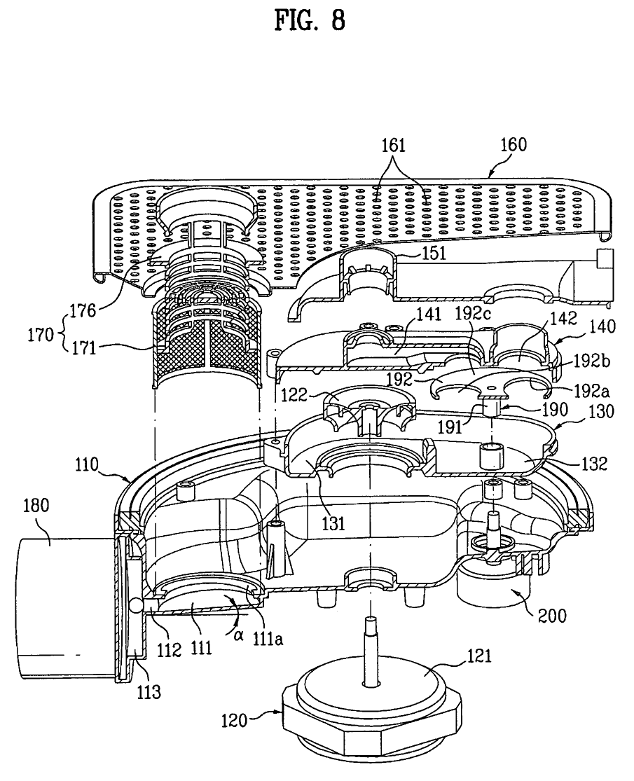

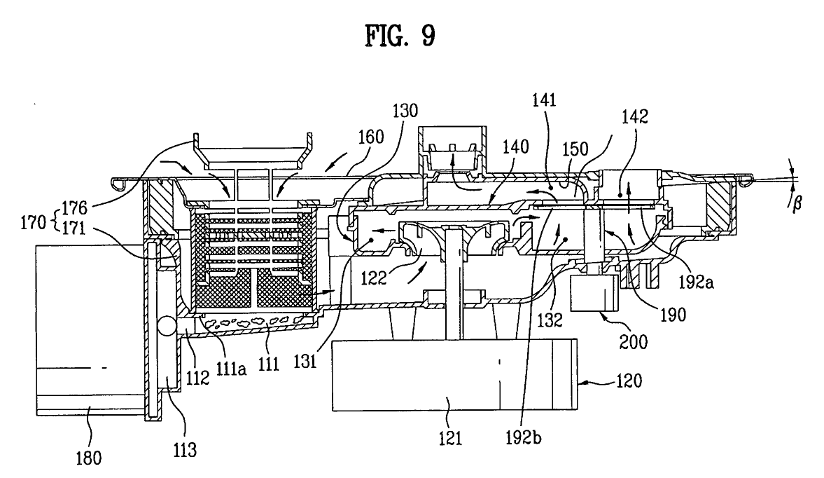

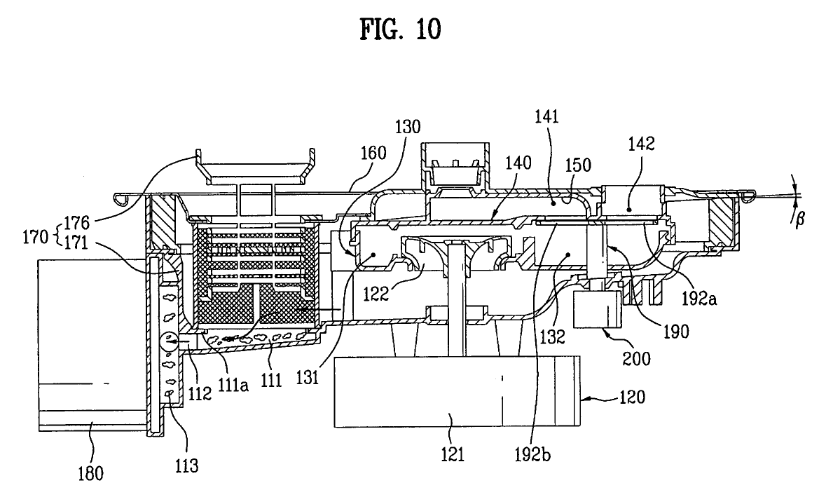

FIG. 7 is a schematic view illustrating a disc type passage control valve for a dish washer according to the present invention. FIG. 8 is an exploded perspective view illustrating a configuration of a dish washer to which the passage control valve of FIG. 7 is applied. FIG. 9 is a sectional view illustrating a flow of wash water during a washing operation of the dish washer of FIG. 8. FIG. 10 is a sectional view illustrating a flow of wash water during a draining operation of the dish washer of FIG. 8.

The passage control valve 190 shown in FIG. 7 includes a passage opening/closing plate 192 having a disc shape, and a rotating shaft 191 coupled to a shaft of a control motor 200. The passage opening/closing plate 192 has an upper washing arm opening portion 192a for opening a passage communicating with an upper washing arm, a lower washing arm opening portion 192b for opening a passage communicating with a lower washing arm, and a passage closing portion 192c for selectively closing the passage communicating with the upper washing arm or the passage communicating with the lower washing arm.

As the control motor 200 rotates, the passage control valve 190 is rotated to open only the passage communicating with the upper washing arm or the passage communicating with the lower washing arm. The passage control valve 190 may also open both the passage communicating with the upper washing arm and the passage communicating with the lower washing arm.

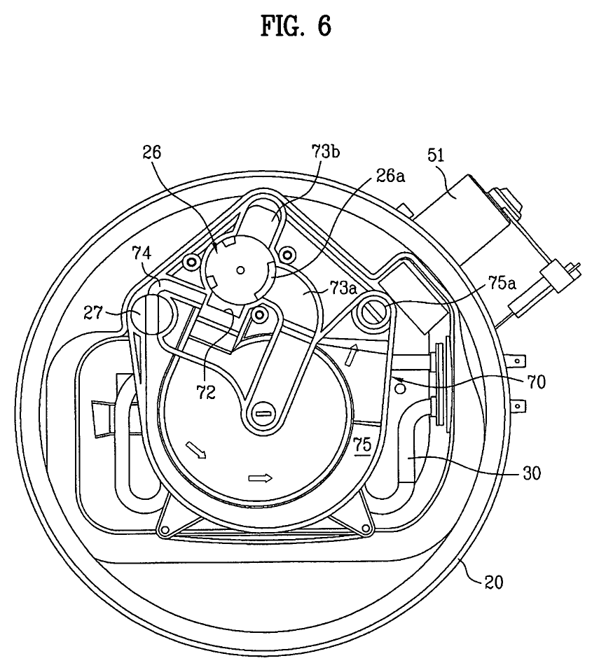

The dish washer shown in FIG. 8 includes the passage control valve shown in FIG. 6. In detail, the dish washer includes a sump 110 for receiving wash water, a washing pump 120 for pumping the wash water from the sump 110, and a housing assembly (including elements 130, 140, and 150) formed with passages 141 and 142 for guiding the pumped wash water to washing arms. The dish washer also includes a cover 160 arranged to cover the top of the sump 110, a filtering device 170 extending downwardly from the cover 160 such that it is arranged in the sump 110, to guide wash water falling onto the cover 160 to the sump 110 after filtering the wash water, and a draining pump 180 communicating with the filtering device 170, and functioning to outwardly discharge garbage separated in the filtering device, along with the wash water present in the sump 110.

Preferably, a heater for heating wash water is arranged in the sump 110. The illustration of the heater is omitted from FIG. 8. It will also be appreciated that the heater may be installed on the bottom of the sump.

The sump 110 is defined with a garbage receiving chamber 111 for storing garbage separated by the filtering device 170. The garbage receiving chamber 111 communicates with the draining pump 180. Preferably, the garbage receiving chamber 111 is arranged in the bottom of the sump 110. More preferably, the garbage receiving chamber 111 is inclined toward the draining pump 180 by a predetermined angle α. In accordance with this inclination, it is possible to easily discharge garbage collected in the garbage receiving chamber 111 to the draining pump 180.

A draining passage 112 is also provided to communicate the garbage receiving chamber 111 and the draining pump 180. Preferably, the garbage receiving chamber 111 is communicated with a draining chamber 113 via the draining passage 112.

The draining chamber 113 is defined in the sump 110, to receive the draining pump 180. The draining chamber 113 has a space for receiving an impeller, and a space for receiving garbage.

The washing pump 120 includes a washing motor 121 for generating a drive force, and an impeller 122 axially coupled to the washing motor 121. The washing motor 121 is of a vertical drive type in which the shaft of the washing motor 121 extends vertically. The draining pump 180 includes a draining motor (not shown), and an impeller (not shown). The draining pump 180 is of a horizontal drive type in which the shaft of the draining motor extends horizontally.

Meanwhile, the housing assembly is provided with a pumping chamber 131 where the impeller 122 of the washing pump 120 is arranged, and a passage control chamber 132 communicating with the pumping chamber 131. The passage control valve 190 is arranged in the passage control chamber 132. The housing assembly is also provided with main passages 141 and 142 for guiding wash water from the passage control chamber 132 to respective washing arms.

Preferably, the pumping chamber 131 and the passage control chamber 132 are flush with each other, in order to increase the internal space of the sump 110 while reducing the height of the housing assembly (including elements 130, 140, and 150). Also, the main passages 141 and 142 are preferably arranged over the pumping chamber 131 and passage control chamber 132, respectively, in order to reduce the width of the housing assembly.

An example of the housing assembly will be described.

The housing assembly includes a lower housing 130 defined with the pumping chamber 131 and flow control chamber 132, and an upper housing 140 coupled to the lower housing 130 such that the upper housing 140 covers the top of the lower housing 130, and defined with the main passages 141 and 142. In the case of FIG. 7, the lower housing 130 and upper housing 140 are separate from each other. Although not shown, the lower housing and upper housing 140 may be integrated with each other.

Preferably, the housing assembly further includes a connecting housing 150 coupled to the upper housing 140 such that the connecting housing 150 covers the top of the upper housing 140. The connecting housing 150 is also coupled to a connecting tube (not shown) connected to the washing arms. The connecting housing 150 has a coupling portion for coupling the connecting housing 150 to the connecting tube.

Preferably, the cover 160, which covers the sump 110, is arranged to be inclined toward the filtering device 170 by a predetermined angle β (FIG. 8), in order to enable wash water and garbage falling onto the cover 160 to flow easily toward the filtering device 170.

Preferably, a plurality of filtering holes 161 is formed through the cover 160, in order to enable a part of the wash water falling onto the cover 160 to be directly introduced into the sump after being filtered. More preferably, the filtering holes 161 are arranged in a region outside the housing assembly, in order to minimize contamination of the outer surface of the housing assembly by the contaminated wash water.

Meanwhile, the filtering device 170 has an opened lower end. The opened lower end of the filtering device 170 is coupled to the garbage receiving chamber 111. Preferably, the lower end of the filtering device 170 is vertically spaced apart from the bottom of the garbage receiving chamber 111 by a predetermined distance. To this end, a step 111a may be formed at the top of the garbage receiving chamber 11 such that the opened lower end of the filtering device 170 is supported by the step 111a. The draining passage 112 is arranged beneath the step 111a of the garbage receiving chamber 111. Accordingly, garbage received in the garbage receiving chamber 111 can be discharged to the draining chamber 113 via the draining passage 112 without being obstructed by the filtering device 170.

The filtering device 170 includes an upper filter 176 mounted to the cover 160 such that the upper filter 176 communicates with the cover 160, and adapted to primarily filter wash water and garbage falling onto the cover 160, and a lower filter 171 connected to the upper filter 176 and garbage receiving chamber 111, and adapted to secondarily filter the wash water, and thus, to separate garbage from the wash water. The lower filter 171 has an opened lower end.

Preferably, the upper filter 176 is detachably mounted to the cover 160. Also, the lower filter 171 is detachably coupled to the upper filter 176. The upper filter 176 performs a filtering function for separating garbage having a large grain size, whereas the lower filter 171 performs a filtering function for separating garbage having a small grain size not separated by the upper filter 176.

Preferably, the upper filter 176 is protruded from the upper surface of the cover 160 by a predetermined height, in order to enable the user to easily grip and pull the upper filter 176. Of course, it is unnecessary for the upper filter 176 to be upwardly protruded from the cover 160, as long as the user can easily grip and pull the upper filter 176.

As described above, the rotating shaft 191 of the passage control valve 190 is coupled to the shaft of the control motor 200. The passage opening/closing plate 192, which is also included in the passage control valve 190, is arranged at an upper end of the rotating shaft 191, and has a disc shape. The passage opening/closing plate 192 opens or closes the main passages 141 and 142 in accordance with rotation thereof.

The passage control valve 190 is structured such that it receives a pumping pressure from the washing pump 120 at the upper surface of the passage control valve 190. Accordingly, when the pumping pressure is applied, the passage control valve 190 is pressed against the upper housing 140. As a result, the passage control valve 190 is stably supported by the upper housing 140 without rocking laterally.

Hereinafter, operation of the dish washer having the above-described configuration will be described.

The dish washer washes dishes while sequentially or selectively performing pre-washing, main washing, rinsing, hot rinsing, and drying operations. A draining operation is carried out between adjacent ones of the above-mentioned operations. The main washing operation and draining operation will be described hereinafter.

The washing operation of the dish washer will be described with reference to FIG. 9.

When the impeller 122 rotates in accordance with operation of the washing motor 121, wash water present in the sump 110 flows to the pumping chamber 131 and passage control chamber 132.

At this time, in accordance with rotation of the passage control valve 190, the main passages 141 and 142 are communicated with the passage control chamber 132. In this case, the passage control valve 190 may selectively open one of the main passages 141 and 142, or may simultaneously open both the main passages 141 and 142. Alternatively, the passage control valve 190 may alternately open the main passages 141 and 142.

When the main passages 141 and 142 are opened, the wash water in the passage control chamber 132 is supplied to the washing arms via the main passages 141 and 142, respectively, so that the wash water can be injected from the washing arms.

In accordance with the present invention, the pumped wash water is completely supplied to the washing arms because there is no sampling passage, as compared to the conventional case. Accordingly, the amount of wash water injected onto dishes to be washed is increased. Practically, the pumped wash water is completely used only to wash the dishes. Thus, it is possible to use a washing pump having a reduced capacity, as the washing pump 120, as compared to the conventional case. The amount of wash water used can be considerably reduced. In addition, the wash water passages are simple, as compared to the conventional case. Accordingly, it is possible to reduce the flow resistance of wash water, and thus, to achieve an enhancement in pumping ability even when the washing pump 120 has the same capacity as that of the conventional case.

The wash water injected from the washing arms falls onto the cover 160 after washing the dishes. Since the cover 160 is inclined toward the filtering device 170, the wash water falling onto the cover 160 and garbage falling onto the cover after being separated from the dishes by the wash water are introduced into the upper filter 176. The wash water is partially directly introduced into the sump 110 via the filtering holes 161.

Garbage having a large grain size is separated by the upper filter 176. The lower filter 171 separates the remaining garbage not separated by the upper filter 176. Accordingly, only the filtered wash water is introduced into the sump 110.

In accordance with the present invention, it is unnecessary to periodically wash the filtering device 170 during the washing operation. Accordingly, even when a reduced amount of wash water is pumped, as compared to the conventional case, it is possible to obtain the same amount of injected wash water as that of the conventional case. It is also possible to reduce the amount of used wash water.

As the above-described washing operation is continued for a predetermined time, the wash water used to wash the dishes is filtered, and re-used to wash the dishes. As the washing operation is continued, the amount of the garbage collected in the filtering device 170 is gradually increased. After completion of the washing operation, a draining operation is begun.

The draining operation of the dish washer will be described hereinafter with reference to FIG. 10.

When the draining pump 180 operates, the wash water present in the sump 110 is introduced into the garbage receiving chamber 111 via the lower filter 171 in accordance with a suction force generated by the draining pump 180. The wash water is then introduced into the draining chamber 113, together with garbage collected in the garbage receiving chamber 111. Since the garbage receiving chamber 111 is inclined toward the draining chamber 113, the introduction of garbage into the draining chamber 113 can be smoothly achieved. Thereafter, the garbage and wash water present in the draining chamber 113 is outwardly discharged via a draining hole of the draining chamber 113 and a draining hose connected to the draining hole.

In this case, the draining path (the passage between the garbage receiving chamber 111 and the draining chamber 113) is very short. Accordingly, there is little or no garbage in the draining path. In accordance with the above-described operation, the garbage collected in the garbage receiving chamber 111 during the draining operation is completely outwardly discharged.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A dish washer comprising:
an upper washing arm;
a lower washing arm;
a sump for receiving wash water;
a washing pump for pumping the wash water; and
a passage control valve including a passage opening/closing plate having a plate shape and functioning to open/close a passage guiding the wash water to the upper washing arm or to the lower washing arm.

2. The dish washer according to claim 1, wherein the passage opening/closing plate comprises:
an upper washing arm opening portion for opening a passage communicating with the upper washing arm;
a lower washing arm opening portion for opening a passage communicating with the lower washing arm; and
a passage closing portion for selectively closing the passage communicating with the upper washing arm or the passage communicating with the lower washing arm.

3. The dish washer according to claim 1, further comprising:
a pumping chamber where an impeller of the washing pump is arranged; and
a housing assembly having a passage control chamber communicating with the upper washing arm and the lower washing arm,
wherein the passage opening/closing plate is arranged in a passage defined in the passage control chamber to communicate with the upper washing arm and the lower washing arm.

4. The dish washer according to claim 1, wherein the passage opening/closing plate has a disc shape.

5. The dish washer according to claim 4, wherein the passage control valve has a rotating shaft connecting the passage opening/closing plate to a motor.
